(19) United States
(12) Patent Application Publication
(10) Pub. No.: US 2024/0275075 A1
(43) Pub. Date: Aug. 15, 2024

(54) ADVANCED ANTENNA SYSTEMS WITH REDUCED SIDELOBES

(71) Applicant: Telefonaktiebolaget LM Ericsson (publ), Stockholm (SE)

(72) Inventors: Stefan Johansson, ROMELANDA (SE); Sven Petersson, SÄVEDALEN (SE); Henrik Jidhage, HOVÅS (SE)

(73) Assignee: Telefonaktiebolaget LM Ericsson (publ), Stockholm (SE)

(21) Appl. No.: 18/569,870

(22) PCT Filed: Jun. 15, 2021
(86) PCT No.: PCT/EP2021/066105

§ 371 Date: Dec. 13, 2023

(51) Int. Cl. H01Q 21/29; H01Q 1/24; H01Q 21/06

(52) U.S. Cl. CPC H01Q 21/293; H01Q 21/061; H01Q 1/246

(57) ABSTRACT

An advanced antenna system, AAS, comprising a plurality of antenna elements (210), where the AAS extends on a surface (S) defined by a normal vector (N), where an x-direction (x) at a point (P) on the surface (S) is parallel to the normal vector (N) at the point (P), where a z-direction (z) at the point (P) on the surface (S) is tangent to the surface (S) and orthogonal to the x-direction (x), where a y-direction (y) at the point (P) on the surface (S) is tangent to the surface (S) and orthogonal to both the x-direction (x) and the z-direction (z), where the antenna elements (210) are arranged in at least three columns (230) extending in the z-direction (z) on the surface (S), where each column (230) comprises at least two antenna elements (210), where at least two of the columns (230) are arranged offset in the z-direction at respective non-zero offset distances (O), relative to a reference column (REF) of the AAS, such that a first offset distance of a first column differs from a second offset distance of a second column in the AAS.

### TECHNICAL FIELD

The present disclosure relates to advanced antenna systems for wireless communication in, e.g., cellular access networks and over terrestrial microwave radio links. Network nodes and wireless devices comprising the advanced antenna systems are also discussed.

### BACKGROUND

The third generation partnership program (3GPP) fifth generation (5G) and sixth generation (6G) communication systems rely on advanced antenna systems (AAS) to improve radio performance by exploiting the spatial domain. AAS is a key component in both 5G and 6G to improve both capacity and coverage.

An AAS for mobile cellular communication networks is normally required to have a broad primary coverage angular range in the horizontal plane, while in the vertical plane the primary coverage angular range is significantly smaller. Desired primary vertical coverage angular range depends on cell size, height relative to ground of the AAS, user distribution, path loss, etc. Therefore, an AAS typically consists of an array of vertical sub-arrays, in order to optimize the array aperture and number of radio chains with respect to the desired primary coverage angular range. The primary coverage angular range is here defined as the angular range where the AAS is to ensure high antenna gain and by that high effective isotropic radiated power (EIRP) and effective isotropic sensitivity (EIS).

Legacy mobile broad band (MBB) communication frequency bands have traditionally been separated from the frequency bands where satellite communication takes place. MBB communications have therefore only generated very little interference to satellite services. Consequently, no array design consideration has been done for satellite interference. However, new AAS frequency bands are closer to the satellite frequencies and investigations show that the satellite service may potentially be interfered from some AAS products. The requirements on AAS “emission” will vary depending on type of satellite service. Some of the requirements will focus on the average emission from thousands of AAS units and some requirements will focus on the max AAS interference from a single unit.

In light of the above, there is a need for AAS designs with a reduced interference to satellite services. Such AAS designs preferably comprises vertical sub-arrays, where a single radio unit is used to feed more than one antenna element.

An AAS design method is desired which allows to freely select the number of radio chains, column separations, sub-array dimensions and vertical sub-array separations within columns.

### SUMMARY

It is an object of the present disclosure to provide antenna systems which allow MBB communication in frequency bands close to satellite communication frequency bands, without causing too much interference in those satellite frequency bands.

This object is obtained at least in part by an advanced antenna system (AAS) comprising a plurality of antenna elements. The AAS extends on a surface defined by a normal vector, where an x-direction at a point on the surface is parallel to the normal vector at the point, where a z-direction at the point on the surface is tangent to the surface and orthogonal to the x-direction, and where a y-direction at the point on the surface is tangent to the surface and orthogonal to both the x-direction and the z-direction. The antenna elements are arranged in at least three columns extending in the z-direction on the surface, where each column comprises at least two antenna elements. At least two of the columns are arranged offset in the z-direction at respective non-zero offset distances, relative to a reference column of the AAS, such that a first offset distance of a first column differs from a second offset distance of a second column in the AAS.

The proposed solution allows to freely select the number of radio chains to use together with the antenna elements of the AAS, which column separations to have, the sub-array dimensions and vertical sub-array separations within columns to, for instance, maximize desired antenna gain envelope over a targeted coverage angular range without the need of compromises due to sidelobe peaks in the region above the horizon. Given an antenna array dimension in terms of number of antenna elements and a column layout. column offsets relative to an arbitrary z-direction reference position of the AAS can be found, e.g., by optimization or experimentation, which significantly reduces or even eliminates sidelobe peaks which may otherwise cause harmful interference to, e.g., satellite systems.

Generally, as will be explained in the following, the offset distances of the two or more columns are configured to reduce a sidelobe magnitude generated by the AAS. The configuration is preferably performed based on minimization or at least reduction of a cost function based on some form of measure of sidelobe magnitude, as will be explained in the following. The column offsets can then be adjusted in order to obtain a design associated with an improved cost function.

An antenna element may, e.g., comprise any of a patch antenna element, a crossed dipole, and a slot antenna element. Thus, the design techniques proposed herein can be used with most known antenna element types and with most known AAS types, which is an advantage.

According to some aspects, the antenna elements are at least partly arranged in subarrays, where each sub-array comprises at least two antenna elements arranged extending in the z-direction. It is an advantage that the proposed techniques can be used for designing AAS comprising sub-arrays, since this reduces the number of radios needed to feed the antenna elements of the AAS. Each sub-array in the AAS may of course comprise the same number of antenna elements. However, at least one sub-array in the AAS may also comprise a different number of antenna elements (compared to at least one other sub-array of the AAS. This allows for amplitude tapering, which may be desired in some AAS designs.

According to some other aspects, at least one sub-array in the AAS is of a different size measured as an area on the surface, and/or has a different antenna element separation measured along the surface, compared to at least one other sub-array of the AAS. Thus, the sub-arrays may be individually customized in order to achieve some desired AAS characteristic, which is an advantage. The techniques for reducing AAS sidelobes disclosed herein may still be applied, regardless of the sub-array customizations performed.

According to further aspects, at least one of the columns is also arranged offset in the x-direction, i.e., offset in both in the z-direction and in the x-direction. This means that the columns may be offset by a respective vector in a plane normal to the surface of the AAS, thus providing additional design freedom.

The offset distances are preferably configured symmetrically about a z-direction central axis of the AAS. This effectively halves the number of column offsets defined for an AAS, thereby reducing computational processing requirements during the design of an AAS, at least in case all column offsets are optimized during the design procedure.

According to further aspects, the offset distances of the at least two columns may be at least 0.1 wavelengths, and preferably at least 0.2 wavelengths, relative to the reference column of the AAS at a center frequency of a transmission frequency band associated with the AAS. Also, the offset distances of the at least two columns relative to the reference column of the AAS may be at most 1.5 wavelengths at the center frequency of the transmission frequency band associated with the AAS, and preferably at most 1.0 wavelengths. This range of wavelengths have been found to yield acceptable results for a wide range of different AAS dimensions. Most optimal column offset solutions are to be found within these ranges.

Furthermore, a magnitude of a difference between the first offset distance and the second offset distance is preferably larger than 0.1 wavelengths, and more preferably also larger than 0.4 wavelengths at the center frequency of the transmission frequency band associated with the AAS.

According to other aspects, the offset distances are configured with a mean-squared deviation from an average offset distance, relative to the reference column of the AAS, of between 0.05 and 0.3 wavelengths squared at the center frequency of the transmission frequency band associated with the AAS, and preferably about 0.1 wavelengths squared. The offset distances are optionally also configured with a mean offset of between 0.3 wavelengths and 0.7 wavelengths, and preferably about 0.5 wavelengths.

There is also disclosed herein wireless devices and network nodes associated with the above-mentioned advantages, as well as methods, computer programs, and computer program products for designing AAS having reduced sidelobe magnitudes.

### BRIEF DESCRIPTION OF THE DRAWINGS

The present disclosure will now be described in more detail with reference to the appended drawings, where:

FIG. 1 shows an example communication network;

FIGS. 2A-B illustrate example AAS according to prior art;

FIG. 3 is a graph showing the results of a performance evaluation of an AAS according to prior art;

FIGS. 4A-B show example antenna aperture surfaces with respective coordinate systems;

FIG. 5 illustrates antenna element columns with offsets in an x-direction;

FIG. 6 illustrates an AAS according to a first example;

FIG. 7 is a graph showing the results of a performance evaluation of the first example AAS;

FIG. 8 illustrates an AAS according to a second example;

FIG. 9 is a graph showing the results of a performance evaluation of the second example AAS;

FIG. 10 illustrates an AAS according to a third example;

FIG. 11 is a graph showing the results of a performance evaluation of the third example AAS;

FIGS. 12-14 illustrate further example AAS designs with reduced sidelobes;

FIG. 15 is a flow chart illustrating a method for designing an antenna array; and

FIG. 16 shows a computer program product.

### DETAILED DESCRIPTION

Aspects of the present disclosure will now be described more fully hereinafter with reference to the accompanying drawings. The different devices, systems, computer programs and methods disclosed herein can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

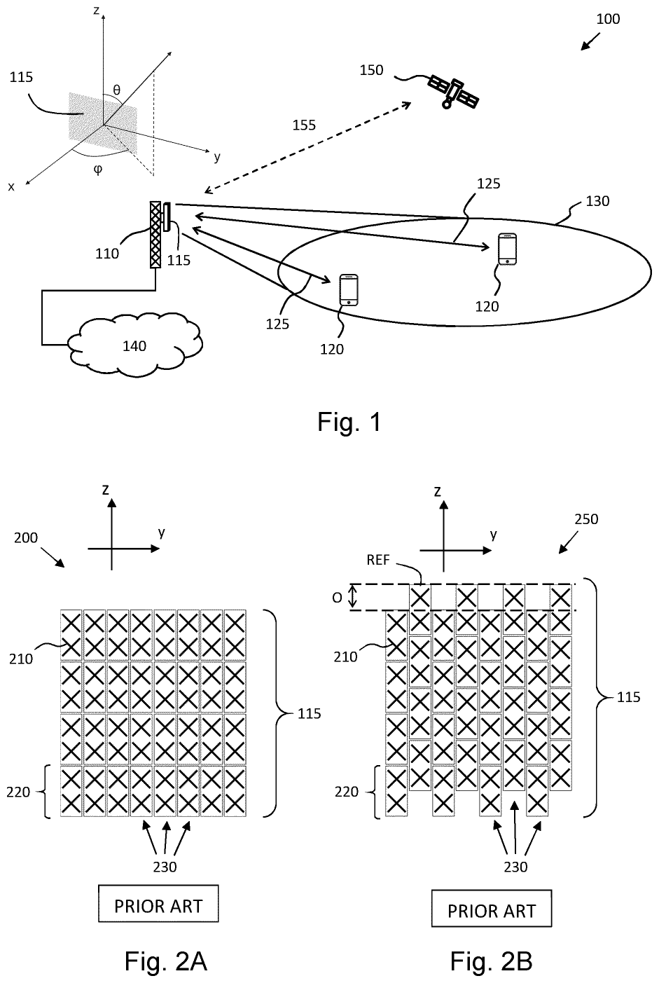

FIG. 1 illustrates an example communication system 100 comprising a network node 110 configured to serve a number of wireless devices 120 via wireless links 125. The network node 110 is connected to a core network 140, and thus provides connections for data and voice traffic between the wireless devices 120 and the core network 140. The network node 110 comprises an advanced antenna system (AAS) 115 arranged to provide coverage over a coverage area 130. The AAS improves radio performance of the communication system by exploiting the spatial dimension in a known manner, e.g., by beamforming techniques.

A reference coordinate system of the AAS is shown in FIG. 1, comprising an x-direction, a y-direction, and a z-direction. The horizontal direction of transmission is denoted φ and the vertical direction of transmission is denoted θ, when the x-direction and y-direction both lie in the horizontal plane. The network node 110 is associated with a primary coverage angular range over angles θ and φ, which may be a subset of the coverage area 130, here defined as the angular range where the AAS is to ensure high antenna gain and by that high EIRP and EIS.

The AAS 115 of the network node 110 may be assembled in relation to a vertical plane intersecting the network node 110. In some cases the AAS is planar and aligned with the vertical plane, i.e., a normal vector of the planar AAS lies in the horizontal plane. In other cases the AAS is arranged with a tilt relative to the vertical plane, often in direction of the wireless devices, i.e., a downwards tilt. For instance, an angle between the surface of the AAS and the vertical plane intersecting the network node 110 may be configured at a value say, below 25 degrees, and preferably smaller than 10 degrees.

Figure I also shows a satellite unit 150 arranged to communicate in a satellite communication frequency band over a radio link 155. Traditionally, the satellite communication frequency bands have been separated from the frequency bands used for MBB communications in cellular access networks such as the communication system 100. Thus, no specific requirements on interference from cellular access networks to satellite communication systems have been imposed on the AAS design of, e.g., the AAS 115. However. recent frequency allocations are moving closer to the satellite frequency bands. Thus, if the AAS 115 transmits signals in direction of the satellite, interference to the satellite communication system may occur.

The AAS examples discussed herein may be the most suitable for use in network nodes like a radio base station. However, some wireless devices may also comprise AAS, and may have use for the herein disclosed techniques as well.

FIGS. 2A and 2B illustrate some typical examples of AAS products according to prior art. FIG. 2A shows an example of an AAS 200 with 64 radio chains feeding an array 115 of 2-element vertical sub-arrays 220 in a 4 row times 8 column configuration, where each vertical sub-array comprises two dual-polarized antenna elements 210. FIG. 2B illustrates an example AAS 250 with 64 radio chains feeding an array of 2-element vertical sub-arrays 220 in a 4 row times 8 column configuration, where a triangular array geometry has been used. The triangular array geometry offsets every other column by an offset distance O in vertical direction, as shown in FIG. 2B. Notably, the same non-zero offset distance O is used for every column that is offset from the reference column REF. Generally, for triangular array geometries like that in FIG. 2B, for an arbitrary selection of reference column REF, there is only a single non-zero offset distance among all columns.

The antenna elements 210 are schematically illustrated as “crossed dipoles”, just to indicate that each antenna element optionally comprises two antenna ports with orthogonal polarization. Each antenna element is also associated with a respective radiation center. It is appreciated that the AAS discussed herein are not limited to any particular form of antenna element, however, normally, an antenna element 210 comprises a patch antenna element, crossed dipole, or a slot antenna element. It is furthermore appreciated that a schematic drawing like that in FIGS. 2A and 2B indicates antenna element geometry, and also the sub-array configuration of the AAS, although the schematic drawing does not necessarily reflect the physical appearance of the AAS.

The teachings herein are applicable also to single polarized antenna elements, i.e., the AAS need not necessarily comprise dual-polarized antenna elements.

In the technical field of antenna engineering, sidelobes are the lobes (antenna diagram local maxima) of the far field radiation pattern of an antenna that are not the main lobe. The radiation pattern of most antennas shows a pattern of “lobes” at various directions where the radiated signal strength reaches a maximum, separated by angular ranges where the radiated signal strength falls to a lower value. This can be viewed as the diffraction pattern of the antenna. In a directional antenna in which the objective is to emit the radio waves in one direction. the lobe in that direction is designed to have a larger field strength than the others; this is the “main lobe”. The other lobes are called sidelobes and usually represent unwanted radiation in undesired directions. For discrete aperture antennas (such as phased arrays) in which the element spacing is greater than a half wavelength, the spatial aliasing effect causes some sidelobes to become substantially larger in amplitude, in some cases approaching the level of the main lobe; these are often called grating lobes. Due to the symmetry of the antenna element arrangements in FIG. 2A and 2B, and the geometry of the sub-arrays in particular, grating lobes are likely to occur, at least in some directions of radiation. A draw back of having AAS's consisting of arrays of vertical subarrays is the high sidelobe peaks caused by the grating lobes generated when steering beams over the desired primary coverage angular range. The problem is that these sidelobes will appear above the horizon and can cause interference with satellite and other airborne systems 150.

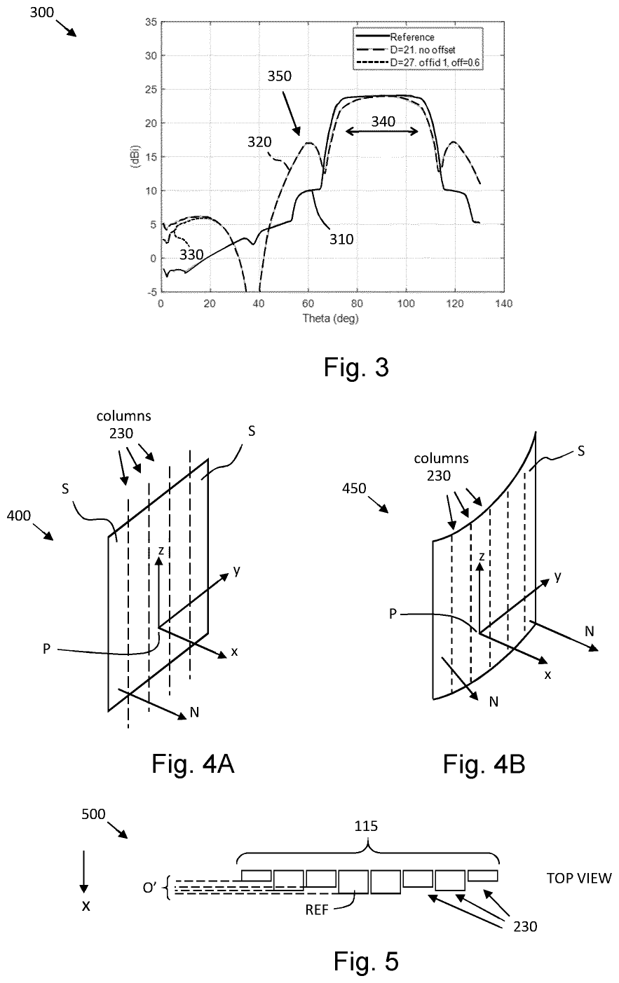

FIG. 3 is a graph 300 showing examples of maximum directivity levels over the continuous angular range −90°≤φ≤90°, for each elevation angle θ, when steering a uniformly excited main beam over a primary coverage angular range 340 configured at 75°≤θ≤105° and −60°≤φ≤60°.

Herein, uniformly excited means that the sub-arrays 220 of the AAS are excited with equal amplitude and a phase giving maximal directivity at the desired angle (θ,φ). The angles are defined according to the coordinate system shown in FIG. 1. A graph such as the graph 300 may be referred to as an envelope pattern of the AAS, since it indicates the maximum directivity levels which can be expected for a given elevation angle θ. Thus, it is appreciated that the graph 300 is not the type of graph usually referred to as a radiation pattern of the AAS.

The curve 310 is a reference curve indicating predicted results for an array of individually steered single antenna elements, i.e., where each element is connected to its own radio unit, with element positions in squared configuration corresponding to the example AAS 200 in FIG. 2A.

The curve 320 shows predicted results for the array 200 of 2-element vertical sub-arrays shown in FIG. 2A.

The curve 330 shows predicted results for the array 220 of 2-element vertical sub-arrays shown in FIG. 2B. This curve is very close to the curve 320, with only some minor differences for about θ<15°.

Comparing the curve 310 to the curves 320 and 330, it is seen that the peak sidelobe levels (i.e. max directivity levels) is up to 8 dB higher for the case of 2-elements subarrays compared to the reference case of having individually steered single elements in the array. The large magnitude sidelobe 350 may generate interference to other systems, such as the satellite-based communication system 150, and is therefore undesired.

The present disclosure relates primarily to AAS consisting of arrays of vertical sub-arrays. Techniques are described herein which significantly reduce the sidelobe peaks due to grating lobes, e.g., in the region above the horizon where interference to satellite systems may be generated, such as about 0°<θ<80° or so. However, the described sidelobe mitigating techniques are also applicable to AAS without sub-arrays. where all or at least a significant part of the antenna elements is fed by a dedicated radio, although the reduction in sidelobe magnitudes may not be as pronounced in this case.

The proposed solution allows to freely select number of radio chains, column offsets, sub-array dimensions and vertical sub-array separations within columns to, for instance, maximize desired antenna gain envelope over the targeted coverage angular range without the need of compromises due to sidelobe peaks above the horizon.

The basic principle of the proposed solution is to mitigate sidelobe peaks by introducing vertical offsets, or relative displacements in the z-direction, between the columns in the array in at least two steps. Examples will be presented below which demonstrate that sidelobe peaks due to grating lobes can be significantly reduced, to the point where they are more or less eliminated. In fact, in some cases the sidelobe levels generated by AAS with sub-arrays are even smaller than for a corresponding size single clement AAS where each antenna element is fed by its own dedicated radio unit.

FIGS. 4A and 4B show two example AAS surfaces 400, 450. The first surface is a planar surface commonly used for antenna arrays, while the second surface is an example developable surface with a curvature. The antenna elements are normally arranged in columns 230 extending in the z-direction, where each column comprises at least two antenna elements. The antenna elements comprised in one column may often be separated from the antenna elements comprised in a neighboring column by a straight line extending in the z-direction. However, this may not always be the case. In case the columns are not offset from each other, the antenna elements often appear in rows, as illustrated in FIGS. 2A and 2B. Rows may still be defined also if the columns are offset, however, the concept of a row may not be as useful in this case. Each AAS discussed herein extends on a surface S defined by a normal vector N, as shown in FIGS. 4A and 4B, where an x-direction at a point P on the surface S is parallel to the normal vector N at the point P, a z-direction at the point P on the surface S is tangent to the surface S and orthogonal to the x-direction, and where a y-direction at the point P on the surface S is tangent to the surface S and orthogonal to both the x-direction and the z-direction. Thus, the techniques discussed herein are applicable to planar AAS comprising antenna panels without curvature, and also to non-planar surface panels such as curved panels.

The columns 230 may be offset in the z-direction, as will be discussed at length below. However, as illustrated in the AAS 500 shown in FIG. 5, the columns may also be offset in the x-direction, again relative to some reference column REF of the AAS. The surface S is in this case taken to be the average x-direction position of the columns, i.e., the surface will exhibit some variation in the x-direction. Indeed. when viewed from an angle, columns offset in the x-direction will appear offset in the z-direction.

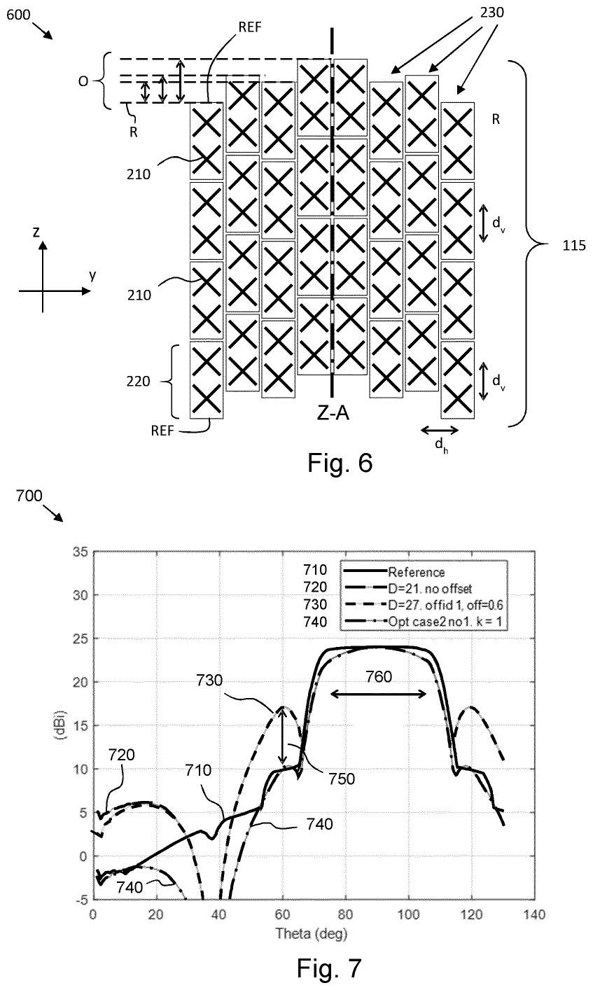

FIG. 6 shows a planar surface AAS 600, where the proposed techniques have been implemented. Generally, for all AAS discussed herein, the antenna elements 210 are arranged in at least three columns 230 extending in the z-direction and there are at least two antenna elements in each column. To reduce sidelobe magnitudes, at least two of the columns 230 are arranged offset in the z-direction at respective non-zero offset distances O, relative to a reference column REF of the AAS, such that a first non-zero offset distance of a first column differs from a second non-zero offset distance of a second column in the AAS. It has been found that this difference in z-direction position among at least three of the columns breaks up the symmetry in the AAS and significantly reduces the magnitude of the sidelobes. The magnitude of the offsets for each column can be determined by computer simulation and/or laboratory experimentation, and it is appreciated that even a sub-optimal vector of column offsets may provide a significant reduction in sidelobe magnitude. An offset relative to the reference column of more than 0.1 wavelengths at the center frequency of communication is often required in order to obtain the desired effect, although the exact preferred offset distances vary depending on the overall specification of the AAS. Also, the first and the second offset distances normally differ by more than 0.1 wavelengths. Three examples will be discussed below which illustrate the general principles of the proposed AAS design technique.

It is appreciated that the offset of a column may be defined in different ways. However, in order to promote readability and understanding of the AAS design concepts discussed herein, and not overly complicate the disclosure, the z-direction offset of a column relative to the reference column REF is herein defined as the difference in z-direction positions between the two columns.

The z-direction position of a column may be determined in different ways, although the same definition of z-direction position should of course be used for all columns. For instance, the position of the uppermost antenna element can be used as the z-direction position of a column, as indicated in, e.g., FIG. 6. According to another example, the average antenna element position of a column can be used as measure, of the z-direction position of the column. In this case the z-direction offset of a column may be defined as the distance from the average antenna element position in z-direction of the column compared to the average antenna element position in the z-direction of the reference column. This means that, even if the total z-direction extension of each column is the same as that of the reference column, an offset in z-direction may still be present if the average antenna clement position in z-direction of the columns differs. In the examples discussed below, the position of the uppermost antenna element will be used as the z-direction position of a column, just to illustrate the general concept.

Both positive and negative offsets relative to the reference column are possible. Also, without loss of generality, one or more columns in the AAS may be located at the same z-direction position, as long as at least two of the columns 230 in the AAS are arranged offset in the z-direction at respective non-zero offset distances relative to the reference column REF of the AAS, such that a first offset distance of a first column differs from a second offset distance of a second column in the AAS.

FIG. 7 is a graph 700 showing examples of maximum directivity levels over a continuous angular range of −90°≤φ≤90°, for each elevation angle θ, when steering a uniformly excited main beam over a primary coverage angular range 760, which in this case is configured at 75°≤θ≤105° and −60°≤φ≤60°.

The symbol A will be used throughout to denote wavelength at a center frequency of a transmission frequency band associated with the AAS.

The column offsets (in y-direction) are selected to be dₕ=0.52λ and the vertical element separation (in z-direction) is configured as dᵥ=0.63λ, i.e. the vertical separation between sub arrays is 1.26λ. The curve 710 corresponds to the reference AAS where each antenna element is separately fed, where the antenna elements are laid out as in FIG. 2A. The curves 720, 730 show the results for the AAS 200 and 250.

The curve 740 illustrates the performance of the AAS 600, where the column offsets have been optimized according to the proposed technique to minimize the peak sidelobe levels in the angular range 0°≤θ≤50° and −90°≤φ≤90° when steering a uniformly excited main beam over the primary coverage angular range 760.

The resulting column offsets are given in the table below, where the offsets are given with respect to the z-direction position of the first column which has been selected as the reference column.

| Column No: | 1 (REF) and 8 | 2 and 7 | 3 and 6 | 4 and 5 |
|---|---|---|---|---|
| Offset (λ): | 0 (R) | 0.45 | 0.35 | 0.70 |

The average offset x̅ for K columns can be determined as

$$\\ \overline{x} = \frac{1}{K} {\sum }_{i = 1 .. {}_{} K} {x}_{i}$$

where xᵢ is the offset of the i:th column. The mean squared deviation from the average offset can be determined as

$$\\ MSE = \frac{1}{K} {\sum }_{i = 1 .. {}_{} K} {( \overline{x} - {x}_{i} )}^{2}$$

The average offset x̅ for the K=8 example in FIG. 6 is 0,375 wavelengths (λ) and the mean squared deviation is approximately 0,063 wavelengths squared.

Note the sidelobe suppression 750 achieved by this offset optimization of the columns. From FIG. 7 it is seen that the peak sidelobe levels within an angular range of about 0°≤θ≤65° and −90°≤φ≤90° are reduced by 7-8 dB when comparing the predicted results for the optimized solution with the results of the prior art AAS. In fact, the peak sidelobe levels are on par or even lower than for the case of having all single elements individually steered in the same array geometry.

It should also be noted that there is no difference in gain envelope over the targeted primary coverage angular range 760 when comparing the optimized solution (curve 740) with the results of the original solution (curves 720, 730). I.e. there is no penalty taken in the primary coverage angular range 760 to accomplish reduced peak sidelobe levels. Thus, notably, the performance in horizontal plane beam-steering is not affected by these offsets, nor is the performance of the AAS in the vertical plane primary coverage angular range affected.

As mentioned above, the technique proposed herein is not limited to AASs comprising sub-arrays where a radio is used to feed more than one antenna element. However, it is an advantage from a cost and complexity perspective to use sub-arrays, since it reduces the number of required radios. Thus, according to a preferred option, the antenna elements 210 are at least partly arranged in subarrays, where each sub-array comprises at least two antenna elements 210 arranged extending in the z-direction. If the AAS is mounted such that the z-direction coincides with the vertical plane, then the subarrays have a vertical extension. Vertically extending subarrays are advantageously used in case a small vertical coverage is desired.

Although column offset in the z-direction provides the strongest reduction in sidelobes, while not hampering other performance criteria such as coverage angular range in the horizontal plane etc., it is appreciated that columns may also be offset on other directions, in addition to the z-direction. For instance, the columns may also be arranged offset in the x-direction, as illustrated in FIG. 5.

The offset distances O are advantageously configured symmetrically about a z-direction central axis Z-A of the AAS, as illustrated, e.g., in FIG. 6. This has the advantage of reducing the number of optimization parameters when determining the offset distances that provide suitable reduction in sidelobes.

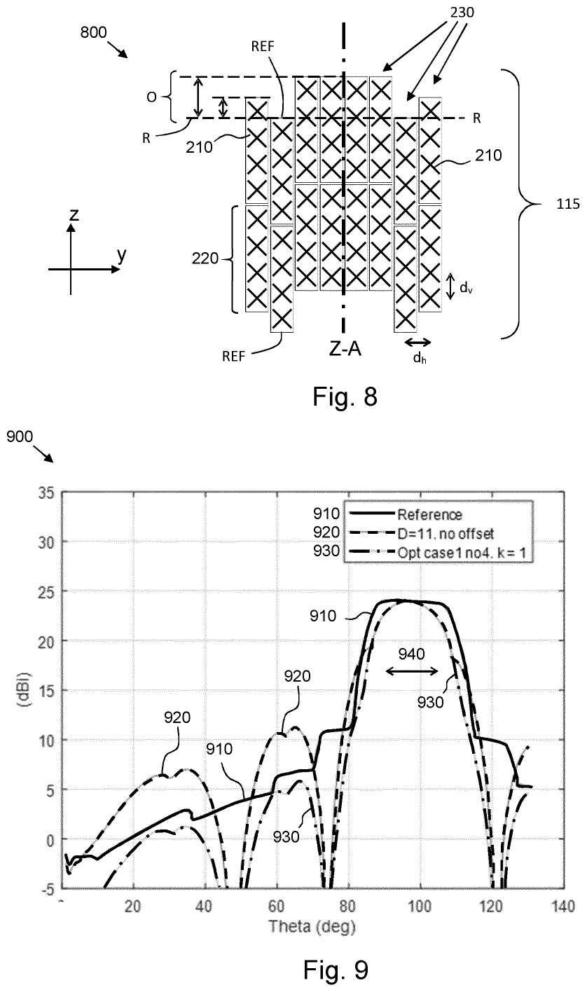

FIG. 8 shows an example AAS 800 with 32 radio chains feeding an array 115 of 4-element vertical sub-arrays 220 in a 2 row times 8 column configuration. The column offsets are selected to dₕ=0.53λ and the vertical element separation to dᵥ=0.63λ, i.e. the vertical separation between sub arrays 220 is 2.52λ. The sub-arrays also have fixed electrical down-tilt of 7 .

FIG. 9 is a graph 900 which shows examples of maximum directivity levels over the continuous angular range −90°≤φ≤90°, for each elevation angle θ, when steering a uniformly excited main beam over a primary coverage angular range 940, here configured at 90°≤θ≤105° and −60°≤φ≤60°.

FIG. 9 shows predicted results 930 for the AAS 800, where the column offsets have been optimized according to the proposed technique to minimize the peak sidelobe levels in the continuous angular range 0°≤θ≤70° and −90°≤φ≤90° when steering a uniformly excited main beam over the primary coverage angular range 940, i.e., 90°≤θ≤105° and −60°≤φ≤60°. The resulting column offsets, determined by optimization, are given in the table below.

| Column No: | 1 and 8 | 2 (REF) and 7 | 3 and 6 | 4 and 5 |
|---|---|---|---|---|
| Offset (λ): | 0.44 | 0 (R) | 0.97 | 0.97 |

The average offset x̅ for the K=8 example in FIG. 8 is 0,595 wavelengths (λ), and the mean squared deviation is about 0,165 wavelengths squared.

From FIG. 9 it is seen that the peak sidelobe levels within the angular range 0°≤θ≤75° and −90°≤φ≤90° are reduced by 7 dB or more when comparing the predicted results (curve 930) for the optimized solution to the results of the prior art AAS 200 (curve 920). In fact, the peak sidelobe levels are >1 dB lower than for the case having all single elements individually steered in the same array geometry, i.e., curve 910 (but with no column offsets, i.e., a square antenna element layout).

It should also be noted that there is no difference in gain envelope over the targeted primary coverage angular range 940 when comparing the optimized solution to the results of the prior art solution. I.e. there is no penalty taken in the primary coverage angular range to accomplish reduced peak sidelobe levels.

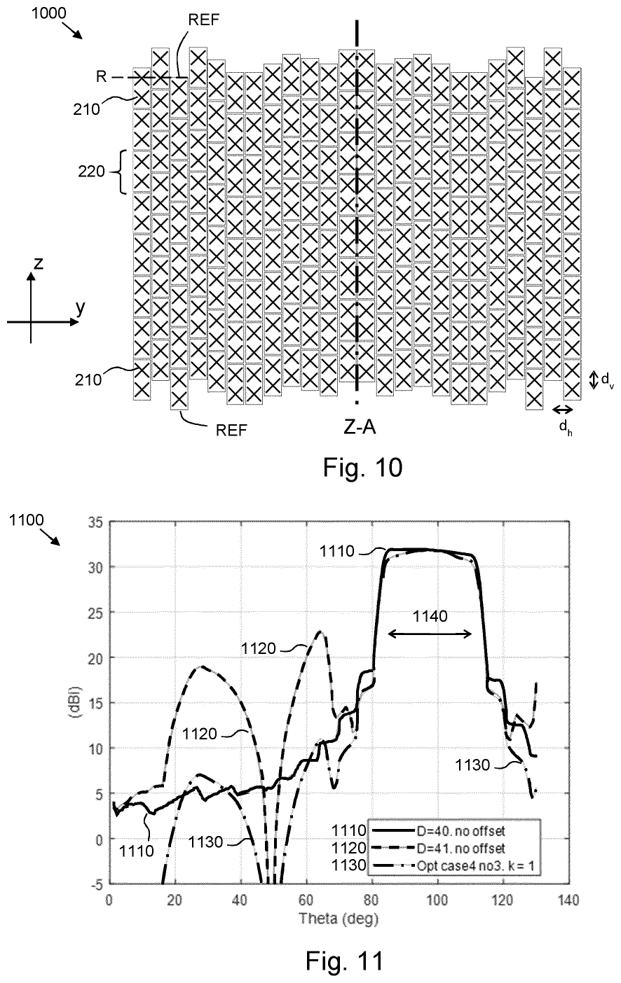

FIG. 10 shows an AAS 1000 with 384 radio chains feeding an array of 2-element vertical sub-arrays (220) in an 8 row times 24 column configuration, i.e., 384 antenna elements. The AAS 1000 is assumed to have a primary coverage angular range 1140 of 85°≤θ≤110° and −60°≤φ≤60°. The column vertical separations are selected to dₕ=0.52λ and the vertical element separation to dᵥ=0.63λ, i.e. the vertical separation between sub arrays is 1.26λ. The sub-arrays also have fixed electrical down-tilt of 8°.

FIG. 11 is a graph 1100 which once again shows examples of maximum directivity levels over the continuous angular range −90°≤φ≤90°, for each elevation angle θ, when steering a uniformly excited main beam over the primary coverage angular range 1140.

FIG. 11 shows predicted results (curve 1130) for the AAS 1000, where the column offsets have been optimized according to the proposed technique to minimize the peak sidelobe levels in the angular range 0°≤θ≤60°, and −90°≤φ≤90° when steering a uniformly excited main beam over the primary coverage angular range 1140. The resulting column offsets are given in the table below.

| | Column No | | | | | | | | | | | |
|---|---|---|---|---|---|---|---|---|---|---|---|---|
| | 1 & | 2 & | 3 (REF) | 4 & | 5 & | 6 & | 7 & | 8 & | 9 & | 10 & | 11 & | 12 & |
| | 24 | 23 | & 22 | 21 | 20 | 19 | 18 | 17 | 16 | 15 | 14 | 13 |
| Offset (λ): | 0.28 | 0.90 | 0 (R) | 0.95 | 0.53 | 0.14 | 0.13 | 0.44 | 0.72 | 0.59 | 0.44 | 0.87 |

The average offset x for the K=24 example in FIG. 10 is around 0,5 wavelengths and the mean squared deviation is about 0,094 wavelengths squared.

From FIG. 11 it is seen that the peak sidelobe levels within the angular range 0°≤θ≤70° and −90°≤φ≤90° are reduced by >11 dB when comparing the predicted results for the optimized solution to the results of the prior art AAS, i.e., curve 1120. The peak sidelobe levels are significantly lower than for the case of having all single elements individually steered in the same array geometry (curve 1110), except that in an angular region around θ=30° and around θ=65° where the peak sidelobe levels are about 1-2 dB higher.

Again, it should be noted that there is no difference in gain envelope over the targeted primary coverage angular range 1140 when comparing the optimized solution to the results of the prior art solution.

The reference curve 1110 here corresponds to the results for an AAS having all single elements individually steered in the same array geometry but with no column offsets, i.e., a rectangular antenna element layout.

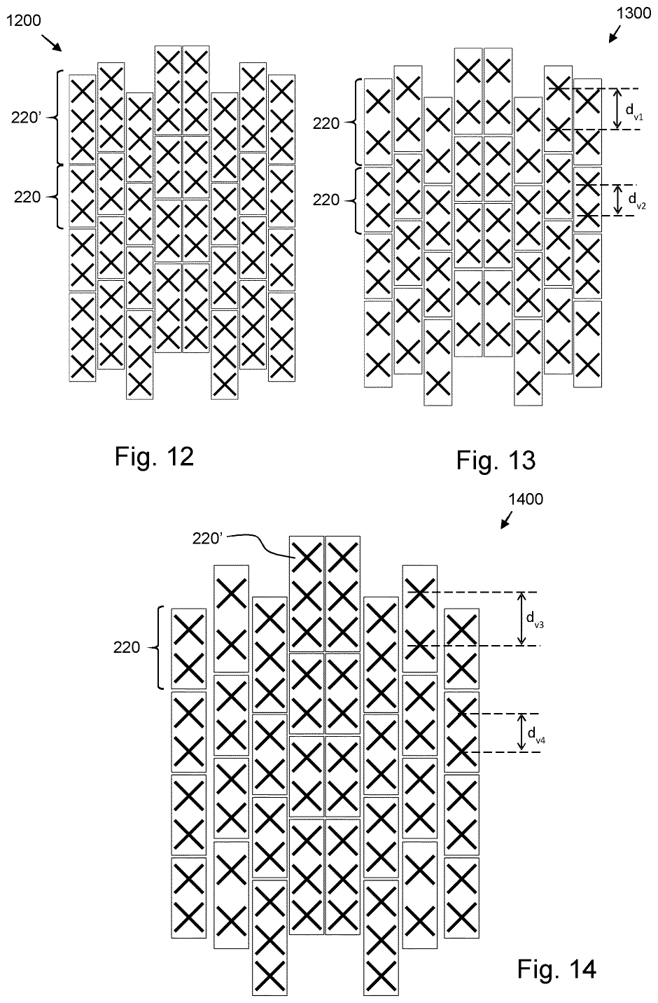

In the examples above AASs consisting of arrays of identical vertical sub-arrays have been considered. However, it should be noted that this invention is not limited to the case of having arrays of identical sub-arrays. To provide additional examples where the herein proposed techniques are applicable with advantage. FIG. 12 illustrates an AAS 1200 where the sub-arrays 220, 220′ comprise different numbers of antenna elements. This type of design may, e.g., be used if amplitude tapering is desired. FIG. 13 illustrates an example AAS 1300 where the spatial extension on the surface for some of the sub-arrays 220 differ, and the antenna element spacings dᵥ₁,dᵥ₂ also differ. FIG. 14 illustrates an example AAS 1400 comprising both different element sub-arrays 220, 220′ as well as sub-arrays with the same number of antenna elements but with different spatial extension on the surface of the AAS, and also different antenna element spacings dᵥ₃, dᵥ₄.

The herein disclosed techniques for reducing sidelobe magnitude comprise offsetting columns in order to break up the symmetry in an AAS where the antenna elements 210 are arranged in columns with at least two antenna elements in each column. The techniques are advantageously used when the antenna elements are grouped into sub-arrays, where each sub-array is fed from a separate radio, and consequently where one radio feeds more than one antenna element. The actual offset distances at which columns should be positioned relative to the reference position R of a reference column REF the AAS of course depends on the overall specification of the AAS and on the desired antenna radiation pattern. Thus, the offsets are preferably determined on a case-by-case basis in dependence of a desired AAS performance.

Generally, the column offsets required to obtain a reduction in sidelobe magnitude are at least 0.1 wavelengths, and preferably at least 0.2 wavelengths, relative to the reference column and measured at a center frequency of a transmission frequency band associated with the AAS. Thus, it is appreciated that the offsets are visually noticeable on an AAS. It is furthermore noticed that the desired offsets may exhibit a periodicity on the order of the wavelength, thus, offsets in excess of one wavelength is most likely not necessary, since the same effect can be obtained with smaller offsets. In other words, the offset distances O of the at least two columns 230 are at most 1.5 wavelengths relative to the reference column and measured at the center frequency of the transmission frequency band associated with the AAS, and preferably at most 1.0 wavelengths. It is furthermore noted that the first and the second offset distances are different also from each other, and this difference is often on the order of at least 0.1 wavelengths or so. Thus, according to aspects, the difference between the first offset distance and the second offset distance is larger than 0.1 wavelengths, and preferably larger than 0.4 wavelengths at the center frequency of the transmission frequency band associated with the AAS.

According to aspects, the offset distances O are configured with a mean-squared deviation from an average offset distance of between 0.05 and 0.3 wavelengths squared at the center frequency of the transmission frequency band associated with the AAS, and preferably about 0.1 wavelengths squared.

According to aspects, the offset distances O are configured with a mean offset relative to the reference column of between 0.3 wavelengths and 0.7 wavelengths, and preferably about 0.5 wavelengths.

Generally, the offset distances O are configured to optimize an objective function comprising a sidelobe magnitude and a main lobe radiation pattern. In other words, the offsets are preferably selected so as to minimize sidelobe magnitude, under a constraint of maintaining a main lobe radiation pattern according to some pre-determined specification. According to an example, the peak sidelobe levels over some angular range is minimized. According to another example, the objective function is a hit and miss objective function, where all offset solutions which provide an envelope pattern that abide by some pre-determined mask is deemed acceptable solutions. According to yet another example, the objective function is a weighted objective function of two or more sub-functions, where each sub-function indicates a desire or optimization objective, such as to reduce maximum sidelobe strength, or to meet some legislation requirement.

In practice, the offset distances may be optimized using computer simulation, where an exhaustive search, or a progressive resolution grid search is performed over the range of possible column offsets. This search space is optionally limited by the constraint of symmetry about the central axis Z-A illustrated in, e.g., FIGS. 6, 8 and 10, which speeds up computations.

As mentioned above, the proposed solution allows to freely select number of radio chains, column offsets, sub-array dimensions and vertical sub-array separations within columns to, for instance, maximize desired antenna gain envelope over the targeted coverage angular range without the need of compromises due to sidelobe peaks above the horizon. The antenna specifications are input to the optimization routine, which then searches through possible candidate column offsets in order to determine a suitable vector of column offsets which meet the requirements on main lobe performance and offer reduced sidelobe magnitude.

Different types of objective functions can be considered when optimizing the column offsets of the AAS, where it is understood that the choice of objective function to optimize, or just improve by some amount, by varying column offset will have an impact on the final AAS design and performance. The objective function may, for instance, comprise an element which penalizes variation over the primary coverage angular range in the horizontal plane as well as in the vertical plane with respect to some reference performance metric. The examples discussed above, in connection to FIGS. 7, 9 and 11 all showed identical performance over the primary coverage angular ranges 760, 940 and 1140, while the sidelobe magnitude outside of this angular range was suppressed significantly.

Generally, the objective function, or cost function, may take the form

$$\\ ( X ) = {\sum }_{j = 1 .. {}_{} J} {w}_{j} {f}_{j} ( X )$$

where [symbol] (X) is the cost associated with an offset vector X=[x₁,x₂, . . . , x_{K}] for an AAS with K columns. There are J functions ƒⱼ(X), optionally weighted by respective weights wⱼ to indicate relative importance between the different functions.

An optimization problem which can be solved in order to arrive at a suitable set of column offsets O may be formulated as

$$\\ O = arg {min}_{X ⊂ {}_{} 𝒳} ( X )$$

for some set of allowable offsets [symbol] . A wide variety of suitable numerical routines for arriving at a suitable vector X=[x₁,x₂, . . . , x_{K}] are known. Hence, practical implementation of the optimization routine will not be discussed in more detail herein.

Alternatively, a number of cost functions [symbol] (X)=ƒₗ(X) can be calculated separately, and a solution selection step can be performed to select a final column offset solution O based on the different cost functions [symbol] (X), i.e., a multi-target optimization.

The functions ƒⱼ(X) may be configured in accordance with the desired properties of the AAS. For instance, a function ƒⱼ can be configured to assume a very large value, even ƒⱼ=∞, in case a sidelobe level in some angular range exceeds a pre-determined spectrum mask of some form, i.e., a kind of hit-or-miss cost function. Another function ƒⱼ can also be configured to assume the value of the highest sidelobe peak in some angular range, i.e., a kind of mini-max criterion. The average maximum EIRP when steering a uniformly excited main beam over some primary coverage angular range may also be a relevant part of the overall cost function.

With reference to FIGS. 7. 9 and 11, there may be some angular ranges a1 ≤θ≤a2, and a3 ≤φ≤a4 where maximum EIRP is more important to limit compared to other ranges. This can be reflected in the cost function by weighting the functions ζⱼ in dependence of angle. I.e., suppose in some scenario that interference in the angular range 40°≤θ≤80° is particularly harmful, then a sidelobe peak in this range can be given more weight in the cost function compared to a peak outside of this range, i.e., in the range 0°≤θ≤10°.

One example objective function is based on a reference value for each angle θ in a predetermined range b1 ≤θ≤b2. This range [b1:b2] suitably indicates where sidelobe peak reduction is desired, and also believed to be possible while still maintaining desired performance in the primary coverage angular range. The reference values can be constant (same for all angles θ). However, more generally, the reference values can be a function where the values are different for different angles θ depending on the importance of obtaining reduced interference as well as what is (believed as) physically achievable. The reference values may, e.g., be selected to equal the results of an AAS where each element is fed by a dedicated radio, i.e., the curves 310, 710, 910, 1110 discussed above in connection to FIGS. 3, 7, 9 and 11.

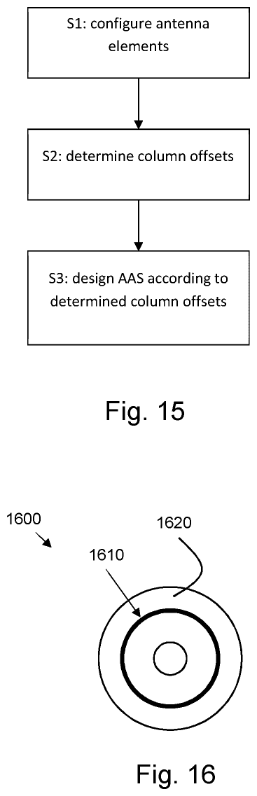

FIG. 15 illustrates a method for designing an advanced antenna system 115, 600, 800, 1000, 1200, 1300, 1400 comprising a plurality of antenna elements 210, where the AAS extends on a surface S defined by a normal vector N, where an x-direction x at a point P on the surface S is parallel to the normal vector N at the point P, where a z-direction z at the point P on the surface S is tangent to the surface S and orthogonal to the x-direction x, where a y-direction y at the point P on the surface S is tangent to the surface S and orthogonal to both the x-direction x and the z-direction. The method comprises configuring SI the antenna elements 210 in at least three columns 230 extending in the z-direction z, where each column 230 comprises at least two antenna elements 210, determining S2 respective column offset distances O for offsetting columns 230 in the z-direction, relative to a reference column of the AAS, such that a first non-zero offset distance of a first column differs from a second non-zero offset distance of a second column in the AAS, and designing S3 the AAS by arranging the columns on the AAS according to the determined offsets.

According to aspects, the method also comprises determining S21 the respective column offset distances O by computer simulation and/or by laboratory experimentation.

According to aspects, the computer simulation and/or the laboratory experimentation is associated with an objective function comprising sidelobe magnitude.

According to aspects, the computer simulation and/or the laboratory experimentation is associated with an objective function comprising main lobe pattern.

According to aspects, the computer simulation and/or the laboratory experimentation is associated with an objective function comprising a transmission mask pattern.

FIG. 16 illustrates a computer readable medium 1720 carrying a computer program comprising program code means 1710 for performing the methods illustrated in, e.g., FIG. 15, when said program product is run on a computer. The computer readable medium and the code means may together form a computer program product 1600.

1. An advanced antenna system AAS, comprising a plurality of antenna elements,
where the AAS extends on a surface (S) defined by a normal vector (N), where an x-direction (x) at a point (P) on the surface (S) is parallel to the normal vector (N) at the point (P),
where a z-direction (z) at the point (P) on the surface (S) is tangent to the surface (S) and orthogonal to the x-direction (x), where a y-direction (y) at the point (P) on the surface (S) is tangent to the surface (S) and orthogonal to both the x-direction (x) and the z-direction (z),
where the antenna elements are arranged in at least three columns extending in the z-direction on the surface, where each column comprises at least two antenna elements,
where at least two of the columns are arranged offset in the z-direction at respective non-zero offset distances, relative to a reference column of the AAS, such that a first offset distance of a first column differs from a second offset distance of a second column in the AAS.

2. The AAS according to claim 1, where the antenna elements are at least partly arranged in subarrays, where each sub-array comprises at least two antenna elements arranged extending in the z-direction (z).

3. The AAS according to claim 1 where each sub-array in the AAS comprises the same number of antenna elements.

4. The AAS according to claim 1, where at least one sub-array in the AAS comprises a different number of antenna elements compared to at least one other sub-array of the AAS.

5. The AAS according to an y-previous claim 1, where at least one sub-array is of a different size measured as an area on the surface (S), and/or has a different antenna element separation measured along the surface (S), compared to at least one other sub-array of the AAS.

6. The AAS according to claim 1, where the surface (S) is a developable surface.

7. The AAS according to claim 1, where the surface (S) is a plane and where the AAS is a planar antenna array.

8. The AAS according to claim 1, where at least one of the columns is also arranged offset (O′) in the x-direction.

9. The AAS according to claim 1, where the offset distances (O) are configured symmetrically about a z-direction central axis (Z-A) of the AAS.

10. The AAS according to claim 1, where the offset distances (O) of the at least two columns relative to the reference column (REF) are at least 0.1 wavelengths at a center frequency of a transmission frequency band associated with the AAS.

11. The AAS according to claim 1, where the offset distances (O) of the at least two columns relative to the reference column (REF) of the AAS are at most 1.5 wavelengths at the center frequency of the transmission frequency band associated with the AAS.

12. The AAS according to claim 1, where a magnitude of a difference between the first offset distance and the second offset distance is larger than 0.1 wavelengths at the center frequency of the transmission frequency band associated with the AAS.

13. The AAS according to claim 1, where the offset distances (O) are configured with a mean-squared deviation from an average offset distance of between 0.05 and 0.3 wavelengths squared at the center frequency of the transmission frequency band associated with the AAS.

14. The AAS according to claim 1, where the offset distances (O) are configured with a mean offset of between 0.3 wavelengths.

15. The AAS according to claim 1, where the offset distances (O) of the columns are configured to reduce a sidelobe magnitude generated by the AAS.

16. The AAS according to claim 1, where an antenna element comprises any of a patch antenna element, crossed dipole, and a slot antenna element.

17. The AAS according to claim 1, where offset distance with respect to the z-direction reference position (R) of the AAS is measured from a first or last antenna element position in z-direction of each column.

18. The AAS according to claim 1, where offset distance with respect to the z-direction reference position (R) of the AAS is measured from a mean antenna element position in z-direction of each column.

19. A wireless device comprising an advanced antenna system, AAS, comprising a plurality of antenna elements,
where the AAS extends on a surface (S) defined by a normal vector (N), where an x-direction (x) at a point (P) on the surface (S) is parallel to the normal vector (N) at the point (P), where a z-direction (z) at the point (P) on the surface (S) is tangent to the surface (S) and orthogonal to the x-direction (x), where a y-direction (y) at the point (P) on the surface (S) is tangent to the surface (S) and orthogonal to both the x-direction (x) and the z-direction (z),
where the antenna elements are arranged in at least three columns extending in the z-direction on the surface, where each column comprises at least two antenna elements,
where at least two of the columns are arranged offset in the z-direction at respective non-zero offset distances, relative to a reference column of the AAS, such that a first offset distance of a first column differs from a second offset distance of a second column in the AAS.

20. A network node comprising an advanced antenna system, AAS, comprising a plurality of antenna elements,
where the AAS extends on a surface (S) defined by a normal vector (N), where an x-direction (x) at a point (P) on the surface (S) is parallel to the normal vector (N) at the point (P), where a z-direction (z) at the point (P) on the surface (S) is tangent to the surface (S) and orthogonal to the x-direction (x), where a y-direction (y) at the point (P) on the surface (S) is tangent to the surface (S) and orthogonal to both the x-direction (x) and the z-direction (z),
where the antenna elements are arranged in at least three columns extending in the z-direction on the surface, where each column comprises at least two antenna elements,
where at least two of the columns are arranged offset in the z-direction at respective non-zero offset distances, relative to a reference column of the AAS, such that a first offset distance of a first column differs from a second offset distance of a second column in the AAS.

21. A computer implemented method for designing an advanced antenna system, AAS, comprising a plurality of antenna elements,
where the AAS extends on a surface (S) defined by a normal vector (N), where an x-direction (x) at a point (P) on the surface (S) is parallel to the normal vector (N) at the point (P), where a z-direction (z) at the point (P) on the surface (S) is tangent to the surface (S) and orthogonal to the x-direction (x), where a y-direction (y) at the point (P) on the surface (S) is tangent to the surface (S) and orthogonal to both the x-direction (x) and the z-direction (z),
the method comprising:
configuring (S1) the antenna elements in at least three columns extending in the z-direction (z), where each column comprises at least two antenna elements,
determining (S2) respective column offset distances (O) for offsetting columns in the z-direction, relative to a reference column (REF) of the AAS, such that a first non-zero offset distance of a first column differs from a second non-zero offset distance of a second column in the AAS, and
designing (S3) the AAS by arranging the columns of the AAS according to the determined offsets.

22. The method according to claim 21, comprising determining (S21) the respective column offset distances (O) by computer simulation and/or by laboratory experimentation.

23. The method according to claim 22, wherein the computer simulation and/or the laboratory experimentation is associated with an objective function comprising sidelobe magnitude.

24. The method according to claim 22, wherein the computer simulation and/or the laboratory experimentation is associated with an objective function comprising a main lobe pattern.

25. The method according to wherein the computer simulation and/or the laboratory experimentation is associated with an objective function comprising a transmission mask pattern.

26. A computer program product comprising a non-transitory computer readable medium storing a computer program comprising instructions which, when executed on processing circuitry, cause the processing circuitry to carry out the method according to claim 21.

27. (canceled)
